(19) United States
(12) Patent Application Publication
(10) Pub. No.: US 2019/0146140 A1
(43) Pub. Date: May 16, 2019

(54) GLASS ARTICLES COMPRISING LIGHT EXTRACTION FEATURES

(71) Applicant: CORNING INCORPORATED, CORNING, NY (US)

(72) Inventors: Byungyun Joo, Ithaca, NY (US); Timothy Edward Myers, Painted Post, NY (US); Steven S Rosenblum, Ithaca, NY (US); James Andrew West, Painted Post, NY (US)

(21) Appl. No.: 16/308,713

(22) PCT Filed: Jun. 9, 2017
(86) PCT No.: PCT/US2017/036689

§ 371 Date: Dec. 10, 2018

Related U.S. Application Data
(60) Provisional application No. 62/348,465, filed on Jun. 10, 2016.

(51) Int. Cl. F21V 8/00

(52) U.S. Cl. CPC G02B 6/0043; G02B 6/0055; G02B 6/0051

(57) ABSTRACT

A glass article comprising a first surface and an opposing second surface, wherein the first surface comprises a plurality of light extraction features (220), ones of the plurality of light extraction features (220) having scattering particles and binder material, wherein the plurality of light extraction features produces a color shift Ay<0.01 per 500 mm of length, and wherein a difference in Fresnel reflections at the first surface at 45 degrees measured within the respective glass article at 450 nm and 630 nm is less than 0.015%. A light extracting ink is also provided comprising scattering particles and a binder material, wherein Fresnel reflections between the binder material and an adjacent substrate are substantially invariant with respect to wavelength. A light extracting ink is also provided comprising scattering particles and a binder material, wherein the binder material has an index of refraction equal to that of an adjacent substrate at a single wavelength.

### CROSS-REFERENCE TO RELATED APPLICATIONS

This application claims the benefit of priority under 35 U.S.C. § 119 of U.S. Provisional Application Ser. No. 62/348,465 filed on Jun. 10, 2016, the content of which is relied upon and incorporated herein by reference in its entirety.

### FIELD OF THE DISCLOSURE

The disclosure relates generally to glass articles and display devices comprising such glass articles, and more particularly to glass light guides comprising light extraction features and methods for making the same.

### BACKGROUND

Liquid crystal displays (LCDs) are commonly used in various electronics, such as cell phones, laptops, electronic tablets, televisions, and computer monitors. Increased demand for larger, high-resolution flat panel displays drives the need for large high-quality glass substrates for use in the display. For example, glass substrates may be used as light guide plates (LGPs) in LCDs, to which a light source may be coupled. A common LCD configuration for thinner displays includes a light source optically coupled to an edge of the light guide. Light guide plates are often equipped with light extraction features on one or more surfaces to scatter light as it travels along the length of the light guide, thereby causing a portion of the light to escape the light guide and project toward the viewer. Engineering of such light extraction features to improve homogeneity of light scattering along the length of the light guide has been studied in an effort to generate higher quality projected images.

Currently, light guide plates can be constructed from plastic materials having high transmission properties, such as polymethyl methacrylate (PMMA) or methyl methacrylate styrene (MS). However, due to their relatively weak mechanical strength, it can be difficult to make light guides from PMMA or MS that are both sufficiently large and thin to meet current consumer demands. Plastic light guides may also necessitate a larger gap between the light source and guide due to low coefficients of thermal expansion, which can reduce optical coupling efficiency and/or require a larger display bezel. Glass light guides have been proposed as alternatives to plastic light guides due to their low light attenuation, low coefficient of thermal expansion, and high mechanical strength.

In light guide plates for display devices or other applications, it is desirable for light extracted from the light guide plate to have uniform intensity and color across the entire light guide plate surface. Light can be extracted from the light guide plate by modifying the surface of the light guide plate to destroy the total-internal-reflection (TIR) condition. Typical techniques for modifying the surface of light guide plates include screen printing transparent inks containing particles (screen printing), inkjet printing of inks that form refractive lenslets on the LGP surface (inkjet printing), and laser melting/ablating refractive divots in the surface of the LGP (laser processing). In each of these cases, it is desirable to have the areal coverage of the surface modification low near the LEDs and high far from the LEDs to create uniform light extraction.

Additional methods for providing light extraction features on light guide plates having plastic materials can include, for example, injection molding and laser damaging to produce light extraction features. While these techniques may work well with plastic light guides, injection molding and laser damaging can be incompatible with glass light guides. In particular, laser exposure may jeopardize glass reliability, e.g., may promote chipping, crack propagation, and/or sheet rupture. In addition, laser damaging may produce extraction features that are too small to efficiently extract light from the light guide plate. Increasing the density of such small features may be possible but can increase the length of processing and, thus, the cost and/or time for production. Moreover, laser damaging of glass can create debris and/or defects around the extraction features. Such debris and defects can increase light extraction but, due to their inhomogeneity, may create high-frequency noise that can lead to image artifacts or defects (“mura”). Defects having various shapes and/or sizes can also create wavelength-dependent scattering, which can drive undesirable color shifting. Furthermore, the addition of energy to the glass article via laser can instigate various chemical reactions, which can generate gaseous products that redeposit on the surface of the glass article. These deposits and/or chemical changes in the vicinity of light extraction features can also generate color shift and/or create high-frequency noise.

Accordingly, it would be advantageous to provide glass articles, such as light guide plates, for display devices which address the aforementioned drawbacks, e.g., glass light guide plates having light extraction features which provide enhanced image quality and reduced color shifting and/or high-frequency noise. Further, it would be advantageous to provide an exemplary ink comprising a transparent polymer binder and particles whereby the selection of ink materials and the areal coverage pattern impact the light emission properties of a respective light guide plate.

### SUMMARY

The disclosure relates, in various embodiments, to a glass article comprising a first surface and an opposing second surface, wherein the first surface comprises a plurality of light extraction features, ones of the plurality of light extraction features having scattering particles and binder material, wherein the plurality of light extraction features produces a color shift Δy<0.01 per 500 mm of length, and wherein a difference in Fresnel reflections at an interface of the first surface and the respective extraction feature at 45 degrees measured within the respective glass article at 450 nm and 630 nm is less than 0.015%, less than 0.005%, or less than 0.001%. In additional embodiments, ones of the plurality of light extraction features have a minimum width at the first surface of between 1 micron and 500 microns, a maximum width at the first surface of between 1 micron and 500 microns, an aspect ratio at the first surface of between 1 and 10, or combinations thereof. In further embodiments, the glass article has a thickness of between 0.2 mm and 4 mm. In some embodiments, the glass article has a thickness of 0.7 mm, 1.1 mm or 2 mm. In some embodiments, the glass article further comprises a diffusing film, a brightness enhancing film, or both. In further embodiments, the glass article further comprises one or more light sources coupling light into one or more sides of the glass article. In some embodiments, the plurality of light extraction features provide a light extraction uniformity of >80% across the glass article. In some embodiments, the glass article is curved with a radius of curvature between 2 m and 6 m. In some embodiments, the plurality of light extraction features is present on the first surface in a pattern selected from the group consisting of random, arranged, repetitive, non-repetitive, symmetrical, and asymmetrical. In some embodiments, any one or combination of the diameters and geometries of the light extraction features vary as a function of position on the first surface. In some embodiments, the opposing second surface comprises a second plurality of light extraction features.

The disclosure also relates to a light extracting ink comprising scattering particles and a binder material, wherein Fresnel reflections between the binder material and an adjacent substrate are substantially invariant with respect to wavelength. The disclosure further relates to a light extracting ink comprising scattering particles and a binder material, wherein the binder material has an index of refraction equal to that of an adjacent substrate at a single wavelength. Exemplary light guide plates can include light extraction features containing these light extracting inks. Further, the plurality of light extraction features can produce a color shift Δy<0.01 per 500 mm of length.

The disclosure also relates to a glass article comprising a first surface and an opposing second surface, wherein the first surface comprises a plurality of light extraction features, and wherein the plurality of light extraction features produces a color shift Δy<0.01 per 500 mm of length. In some embodiments, ones of the plurality of light extraction features include a transparent polymer binder with optical dispersion to produce high color uniformity. In other embodiments, the optical dispersion of the binder can be matched to the material of the respective light guide plate.

In some embodiments, a light guide plate is provided having printed light extraction features with an optical dispersion selected to produce high color uniformity. In other embodiments, a binder composition in the light extraction features can be selected to meet the optical transmission, adhesion, and durability requirements of an exemplary light guide plate.

Additional features and advantages of the disclosure will be set forth in the detailed description which follows, and in part will be readily apparent to those skilled in the art from that description or recognized by practicing the methods as described herein, including the detailed description which follows, the claims, as well as the appended drawings.

It is to be understood that both the foregoing general description and the following detailed description present various embodiments of the disclosure, and are intended to provide an overview or framework for understanding the nature and character of the claims. The accompanying drawings are included to provide a further understanding of the disclosure, and are incorporated into and constitute a part of this specification. The drawings illustrate various embodiments of the disclosure and together with the description serve to explain the principles and operations of the disclosure.

### BRIEF DESCRIPTION OF THE DRAWINGS

The following detailed description can be further understood when read in conjunction with the following drawings, wherein, when possible, like numerals refer to like components, it being understood that the appended figures are not necessarily drawn to scale.

FIG. 1 is an illustration of an exemplary light guide plate according to some embodiments;

FIG. 2 is an illustration of a light extraction pattern for some embodiments;

FIG. 3 is an illustration of a light extraction pattern for further embodiments;

FIG. 4 is an illustration of a light extraction pattern for additional embodiments;

FIG. 5 is a schematic, front plan view of an exemplary light guide plate;

FIG. 6 is a simplified schematic of a light extraction feature on a surface of a light guide plate;

FIG. 7A is a simplified schematic of another light extraction feature showing white light incident on the feature;

FIG. 7B is a graph of reflection coefficient of light incident on a light guide plate/PMMA interface at 45 degrees measured within the respective glass article;

FIG. 8 is a graph of material dispersion of an exemplary light guide plate, an ink material, and several simulated dispersions;

FIG. 9 is a series of plots of CIE y color coordinate as a function of distance for the light guide plates modeled in Table 1; and

FIGS. 10A and 10B are plots of Fresnel reflectivity of binders with the functional form of FIG. 8.

### DETAILED DESCRIPTION

### Glass Articles

Disclosed herein are glass articles comprising a first surface and an opposing second surface, wherein the first surface comprises a plurality of light extraction features. Exemplary glass articles can include, but are not limited to, glass light guide plates. Display devices comprising such glass articles are further disclosed herein.

The glass article or light guide plate may comprise any material known in the art for use in displays and other similar devices including, but not limited to, aluminosilicate, alkali-aluminosilicate, borosilicate, alkali-borosilicate, alum ino-borosilicate, alkali-alum inoborosilicate, soda lime, and other suitable glasses. In certain embodiments, the glass article may have a thickness of less than or equal to about 3 mm, for example, ranging from about 0.3 mm to about 2 mm, from about 0.7 mm to about 1.5 mm, or from about 1.5 mm to about 2.5 mm, including all ranges and subranges therebetween. Non-limiting examples of commercially available glasses suitable for use as a light guide plate include, for instance, EAGLE XG®, Gorilla®, Iris™, Lotus™, and Willow® glasses from Corning Incorporated.

The glass article may comprise a first surface and an opposing second surface. The surfaces may, in certain embodiments, be planar or substantially planar, e.g., substantially flat and/or level. The first and second surfaces may, in various embodiments, be parallel or substantially parallel. The glass article may further comprise at least one side edge, for instance, at least two side edges, at least three side edges, or at least four side edges. By way of a non-limiting example, the glass article may comprise a rectangular or square glass article having four edges, although other shapes and configurations are envisioned and are intended to fall within the scope of the disclosure. The glass article may, for example, be substantially flat or planar, or may be curved around one or more axes.

Also disclosed herein is a patterning process in which a transparent glass light guide plate or substrate is patterned with refractive light-extraction features on one surface to produce a color shift of the extracted light Δy<0.01 per 500 mm of length.

Further disclosed herein is a transparent glass light guide plate or substrate having a thickness is between 0.2 and 4 mm (e.g., 0.7 mm, 1.1 mm, 2 mm, or the like) with a pattern of refractive light-extraction features on one surface which produces a color shift Δy<0.01 per 500 mm of length. Such embodiments can be used as a light guide in a backlight unit having one or more diffusing films, brightness enhancing films, and with an LED(s) coupling light into one or more sides of the light guide. In some embodiments, an exemplary pattern of light-extraction features can provide light extraction uniformity of >80% across the light guide. In some embodiments, exemplary light guides can be used in a curved deployment with a radius of curvature between 2 and 6 meters. In further embodiments, exemplary light extraction features can have a minimum width at the glass surface of between 1 and 500 microns, a maximum width at the glass surface of between 1 and 500 microns, and/or an aspect ratio (ratio of maximum to minimum width) at the glass surface of between 1 and 10.

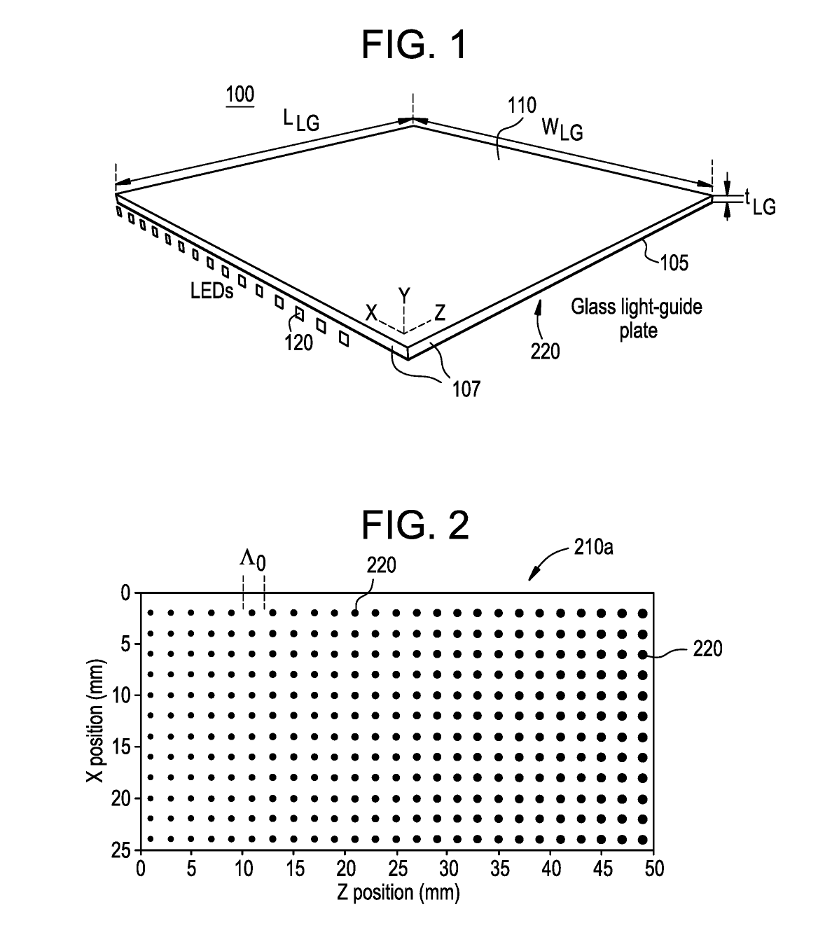

FIG. 1 is an illustration of an exemplary light guide plate according to some embodiments. With reference to FIG. 1, an exemplary glass article 100, e.g., glass light guide or light guide plate, can comprise a first surface 105, a second surface 110, a glass thickness t_{LG} extending between the first and second surfaces 105, 110, a panel width W_{LG} and a panel length L_{LG}. Coupled to one or more edges of the glass article 100 is one or more light sources 120 to provide an input of light to the one or more edges 107 of the glass article 100. While one array of light sources 120 on a single edge 107 is illustrated, such a depiction should not limit the scope of the claims appended herewith as any number of or arrays of light sources 120 can be provided on multiple edges 107 of the glass article 100. As will be illustrated in FIGS. 2-3, a plurality of light extraction features 220 can be present on the first surface 105. It is to be understood, however, that these orientations and labels can be switched without limitation, the surfaces being referred to herein as “first” and “second” solely for the purposes of discussion. Moreover, it is possible, in non-limiting embodiments, for both surfaces of the glass article to comprise light extraction features. For example, the first surface may be provided with light extraction features according to the methods disclosed herein and the opposing second surface may be provided with light extraction features by the same or different methods known in the art. When both surfaces comprise light extraction features, the features can be identical or different in size, shape, spacing, geometry, and so on, without limitation.

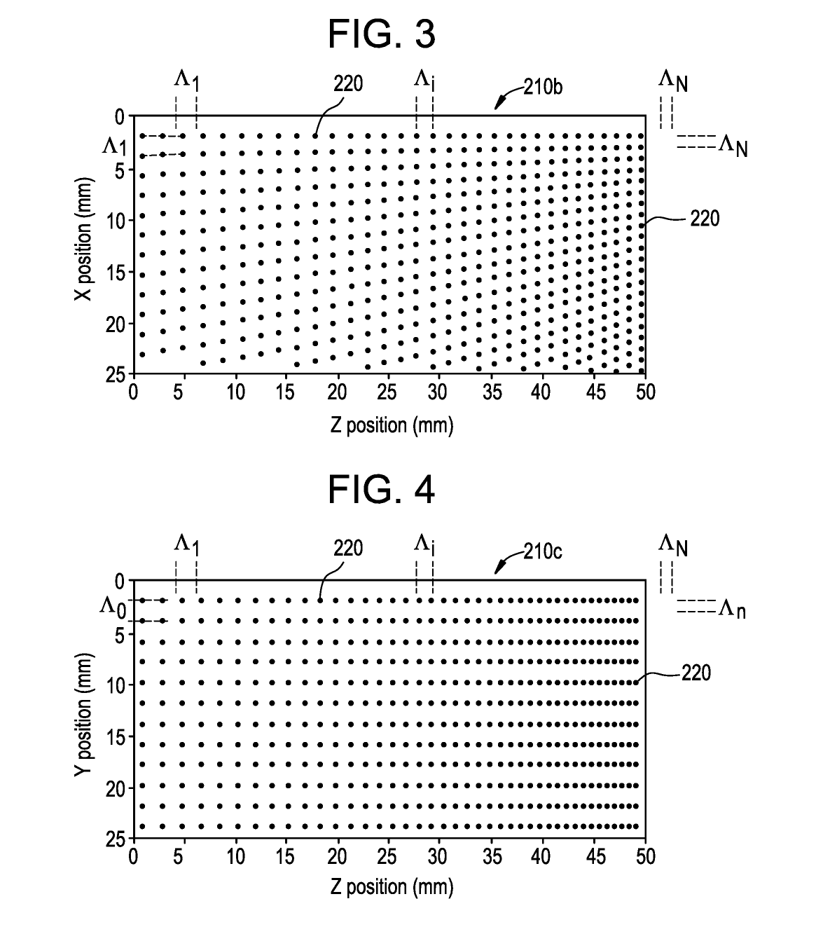

The process of total-internal reflection (TIR) confines the light in such a panel until the light hits a light-extraction feature which disrupts TIR. FIGS. 2, 3 and 4 illustrate non-limiting embodiments of light extraction patterns. With reference to FIG. 2, one pattern 210a of light extraction features according to some embodiments is depicted in which the pitch Λ₀ between light-extraction features 220 remains constant in the X and Z directions. In the depicted, non-limiting embodiment light coupling could occur along the X-axis at Z=0. Thus, to provide for a substantially constant light extraction over an exemplary glass article 100, the areas of light extraction features 220 can increase linearly from Z=0 to Z=L. Of course, the depiction of features in FIG. 2 should not limit the scope of the claims appended herewith as the density of features can be varied, for example, in the Z direction by changing the spacing between neighboring features in both the X and Z directions (see FIG. 3) or by changing the spacing between neighboring features only in the Z direction, or in only the X direction (see FIG. 4). FIG. 3 provides an exemplary light extraction pattern 210b for a patterned light-guide plate or glass article 100 in which the dimensions of the light-extraction features 220 remain constant in X and Z. Light coupling would be along the X-axis at Z=0. For constant light extraction, the density of the light extraction features 220 increases linearly from Z=0 to Z=L. This pattern decreases the feature-to-feature spacing in both the X and Z dimensions. FIG. 4 provides an exemplary light extraction pattern 210c for a patterned light-guide plate or glass article 100 in which the dimensions of the light-extraction feature 220 remain constant in X and Z. Light coupling would be along the X-axis at Z=0. For constant light extraction, the density of the printed light extraction features 220 increases linearly from Z=0 to Z=L. This pattern decreases the feature-to-feature spacing in only the Z dimension.

Using conventional techniques, the size of light-extraction features, the spacing of the features, and the precise pattern are determined by glass thickness, panel length, panel width, glass absorption, edge effects (i.e. reflectivity), and the desired efficiency of the panel where e=1−η_{eff}, where η_{eff}=P (Z=L)/P(Z=0). It follows that if light is constantly being extracted in a uniform fashion per unit length, the amount of light in the waveguide would decrease linearly by exactly the same amount per unit length minus any absorption. The basic linear increase in the area of the features according to conventional techniques would be a consequence of this linear decrease in waveguide power because the amount of scattered light p_{scatt} at position (X,Z) is proportional to the amount of light P(X,Z) in the waveguide at (X,Z) multiplied by the scattering coefficient S(X,Z) at (X,Z). This results in the following equation relating the scattering to the power in the waveguide:

$$S ( z ) = \frac{{p}_{scatt}}{P ( z )} \qquad ( 1 )$$

With reference to equation (1), for a printed pattern the total scattering at position (X,Z) is proportional to the number of small scattering particles in the ink which in turn is proportional to the volume of the ink dot. For screen printing the ink dots are approximately equal in thickness, thus the total scattering at position (X,Z) is proportional to the area of the printed ink dot. In a typical screen-printed light-guide plate the scattering particles are several times larger than the wavelength of the light and the process can be considered as multi-particle Mie scattering. This scattering is mainly in the forward direction and has relatively little wavelength dependence when compared to the more familiar Rayleigh scattering from particles whose size is much less than the wavelength.

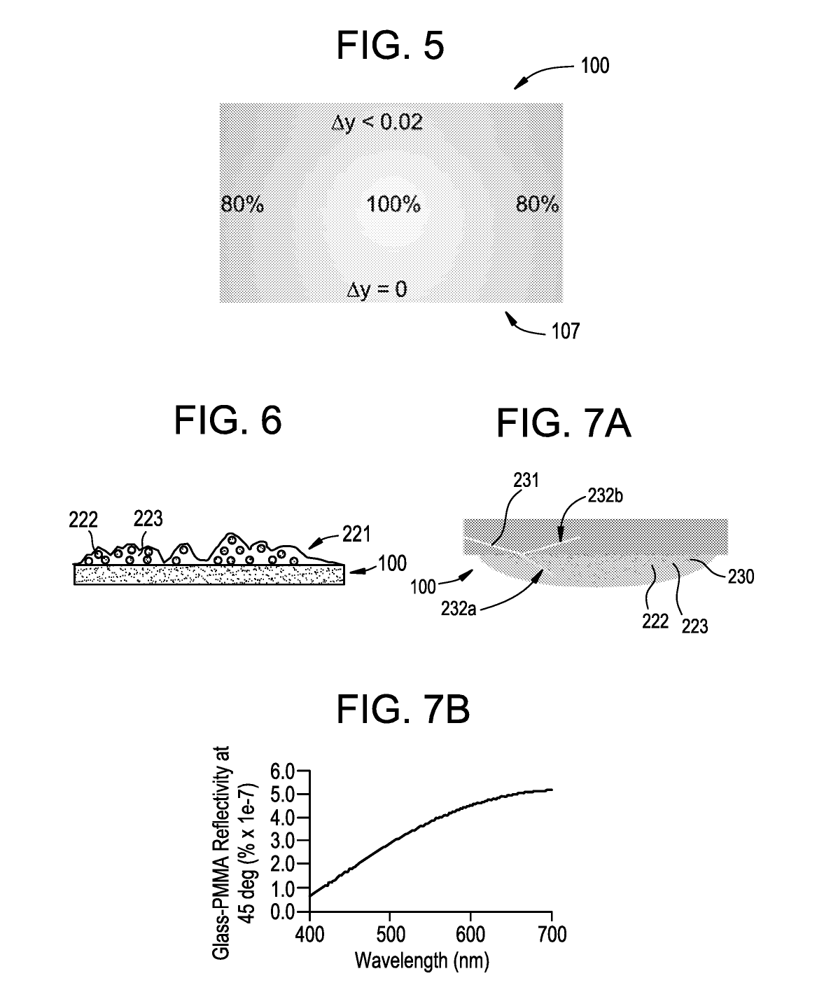

FIG. 5 is a schematic, front plan view of an exemplary light guide plate. With reference to FIG. 5, an exemplary light guide plate 100 is illustrated showing certain optical requirements. Depicted percentages represent brightness, with 100% being the brightest section of the light guide plate 100 and 80% indicating that no part of the light guide plate 100 can have a brightness more than 20% below the peak. Δy represents the shift in the y component of the chromaticity across the panel (i.e., color shift) and is defined to be zero near the LED injection edge 107. FIG. 6 is a simplified schematic of a light extraction feature on a surface of a light guide plate 100, in this case the light extraction feature being an ink drop 221. The ink drop 221 can include a plurality of scattering particles 222 within an exemplary binder material 223. In some exemplary embodiments, the scattering particles 222 can be index matched to the binder material 223 such that the scattering particles 222 serve to create a surface texture that scatters light. If, however, there is an index mismatch between the scattering particles 222 and the binder material 223, then light can undergo volumetric scattering within the ink drop 221 as well as surface scattering.

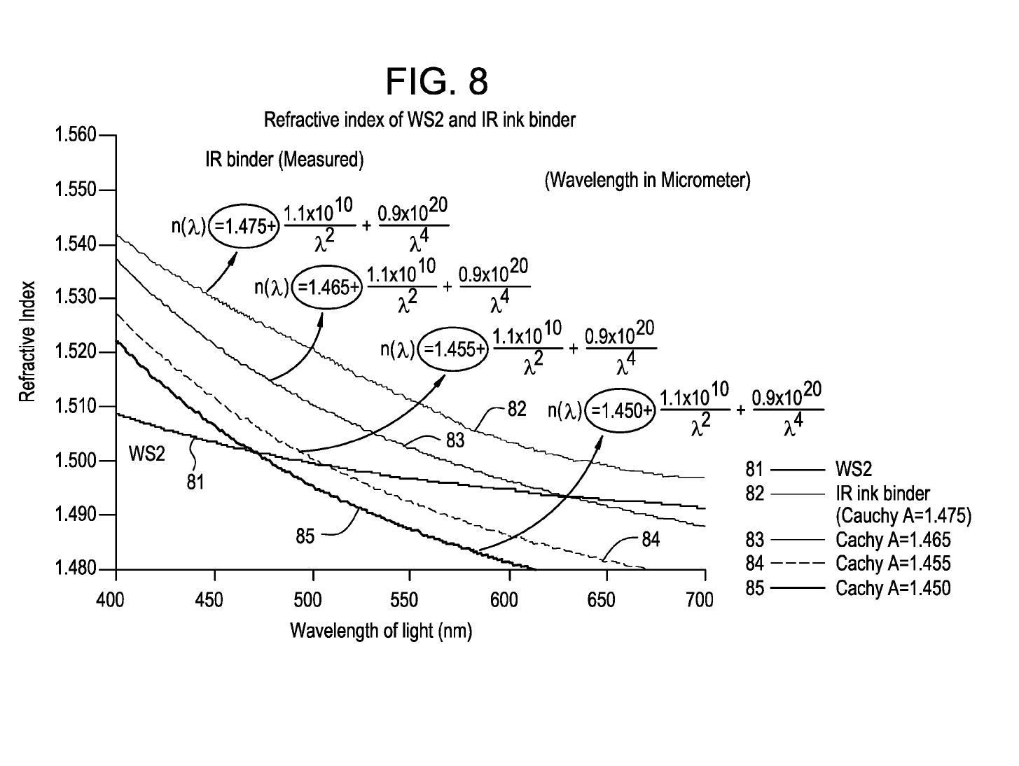

FIG. 8 is a graph of material dispersion of an exemplary light guide plate 81, an ink material 82, and several simulated dispersions 83, 84, 85 used to compute exemplary light guide plate properties. With reference to FIG. 8, it can be observed that a glass light guide plate has a substantially different material dispersion from a polymer material meaning that any light incident on an ink scattering feature will undergo Fresnel reflections using the relationship:

$$R = \frac{1}{2} ( {R}_{s} + {R}_{p} ) \cdot , where \\ {R}_{s} = {\vert \frac{{n}_{1} cos {θ}_{i} - {n}_{2} cos {θ}_{t}}{{n}_{1} cos {θ}_{i} + {n}_{2} cos {θ}_{t}} \vert}^{2} = {\vert \frac{{n}_{1} cos {θ}_{i} - {n}_{2} \sqrt{1 - {( \frac{{n}_{1}}{{n}_{2}} sin {θ}_{i} )}^{2}}}{{n}_{1} cos {θ}_{i} + {n}_{2} \sqrt{1 - {( \frac{{n}_{1}}{{n}_{2}} sin {θ}_{i} )}^{2}}} \vert}^{2} , and \\ {R}_{p} = {\vert \frac{{n}_{1} cos {θ}_{t} - {n}_{2} cos {θ}_{i}}{{n}_{1} cos {θ}_{t} + {n}_{2} cos {θ}_{i}} \vert}^{2} = {\vert \frac{{n}_{1} \sqrt{1 - {( \frac{{n}_{1}}{{n}_{2}} sin {θ}_{i} )}^{2}} - {n}_{2} cos {θ}_{i}}{{n}_{1} \sqrt{1 - {( \frac{{n}_{1}}{{n}_{2}} sin {θ}_{i} )}^{2}} + {n}_{2} cos {θ}_{i}} \vert}^{2} . \qquad ( 2 )$$

where n₁ represents the wavelength dependent refractive index of the light guide and n₂ represents the wavelength dependent refractive index of the binder.

FIG. 7A is a simplified schematic of another light extraction feature showing white light incident on the feature. FIG. 7B is a graph of reflection coefficient of light incident on a light guide plate/PMMA interface at 45 degrees measured within the respective glass article. With reference to FIGS. 7A and 7B, the light extraction feature is depicted as a hemispherical ink drop 230 having scattering particles 222 and binder materials 223 contained therein. As depicted, white light 231 is incident on the light extraction feature 230, and if the light extraction feature 230 preferentially transmits blue light 232a, then the light remaining in the light guide plate 100 will be shifted to yellow 232b. With reference to FIG. 7B, reflection coefficients of light incident on an exemplary light guide plate having a composition described below is provided. As illustrated, the Fresnel reflection coefficient is depicted as a function of wavelength for an interface between an exemplary light guide plate composition (e.g., Iris™ glass) and a polymer (e.g., polymethyl-methacrylate (PMMA)). In can be observed that less blue light is reflected at the interface than longer wavelengths. Lower blue reflectance means that more blue light enters into the light extraction feature (see FIG. 7A). Since most scattering mechanisms are also more efficient at scattering blue light, the index mismatch further aggravates preferential blue scattering in an exemplary light guide plate. Further, as light propagates down an exemplary light guide plate, the increased blue extraction leads to depletion of the blue light in the light guide thus leading to a yellow shift as light moves further from the light source along an edge. Thus, FIGS. 7A, 7B, and 8 and Equation (2) suggest that the refractive index of an exemplary ink binder represents a degree of freedom for significantly improving the color uniformity of a light guide plate according to embodiments of the present disclosure.

Exemplary binder materials include, but are not limited to, photo-polymerized materials, heat cured or heat curable materials, thermoplastics, thermosets, epoxies, acrylates, and other suitable binder materials utilized in the industry. Exemplary scattering particles include, but are not limited to, PMMA, TiO₂, SiO₂, glass beads or other suitable scattering particles. Such scattering particles can have a size (average diameter) between 1 μm and 20 μm, or between 4 μm and 10 μm.

Table 1 below provides exemplary light guide plate performance. In general, the refractive index of a material can be described by Cauchy's equation:

$$n ( λ ) = A + \frac{B}{{λ}^{2}} + \frac{C}{{λ}^{4}} .$$

For example, Case 1, Case 2, Case 3, and Case 4 represent exemplary light guide plates (having a dimension of 692.2 mm×1212.4 mm×2 mm thick) in which light traveling all the way through the light guide plate exits the far side. The light guide plate included an optical film (e.g., one diffuser and BEF). Case 1 included a binder material having a A of 1.475, Case 2 included a binder material having a A of 1.465, Case 3 included a binder material having a A of 1.455, and Case 4 included a binder material having a A of 1.450. Average surface luminance for these cases ranged from 100% (Case 1) and 99% (Case 2) to 89% (Case 3) and 83% (Case 4). Luminance uniformity for these cases ranged from 92% (Cases 1 and 2) to 95% (Case 3) and 93% (Case 4). Case 5, Case 6, Case 7, and Case 8 represent exemplary light guide plates having diffuse reflective (white) tape on the side opposite the light source to reflect light back into the LGP. Case 5 included a binder material having a A of 1.475, Case 6 included a binder material having a A of 1.465, Case 7 included a binder material having a A of 1.455, and Case 8 included a binder material having a A of 1.450. Average surface luminance for these cases ranged from 112% (Case 5) and 111% (Case 6) to 106% (Case 7) and 102% (Case 8). Luminance uniformity for these cases ranged from 92% (Cases 6 and 7) to 88% (Case 5) and 86% (Case 8). In all cases, the pattern of the extraction features was designed to achieve high luminance uniformity. To measure average surface luminance, one can inject LED light into the bottom of an exemplary light guide plate, cover the light guide plate with one diffuser film and two brightness enhancing films (BEFs), and put a reflective sheet behind the light guide plate and then (1) measure the light output with an imaging colorimeter (such as an Eldim UMaster or a Radiant Prometric) such that the angular acceptance of light from the light guide plate to a respective camera is kept below 5 degrees, or (2) measure 9 or more points of the light guide plate with a spectral radiometer such as a Radiant PR670 or PR740 and average the luminance values accordingly. Luminance uniformity is typically defined as the (max(luminance)−min(luminance))/max(luminance) over the region measured for average surface luminance. Luminance uniformity is also defined in Section 5.2.3 of IEC 62595-2, Ed. 1.0, 2012-09.

TABLE 1

| LGP dimension | 692.2 × 1212.4 × 2 | | | | | | | |
|---|---|---|---|---|---|---|---|---|
| (mm) | | | | | | | | |
| Optical film | 1 diffuser and 1 BEF | | | | | | | |
| Refractive | 1.506 (450 nm) | | | | | | | |
| index of | 1.499 (550 nm) | | | | | | | |
| LGP (Iris WS2) | 1.495 (650 nm) | | | | | | | |
| White tape | No white tape | | | | White tape | | | |
| Ink | Case 1 | Case 2 | Case 3 | Case 4 | Case 5 | Case 6 | Case 7 | Case 8 |
| A | 1.475 | 1.465 | 1.455 | 1.450 | 1.475 | 1.465 | 1.455 | 1.450 |
| Volume | On | On | On | On | On | On | On | On |
| scattering | | | | | | | | |
| model | | | | | | | | |
| Ink pattern | Type A | Type B | Type C | Type D | Type E | Type F | Type G | Type H |
| Surface | 100% | 99% | 89% | 83% | 112% | 111% | 106% | 102% |
| luminance (Avg) | | | | | | | | |
| Luminance | 92% | 92% | 95% | 93% | 88% | 92% | 92% | 86% |
| uniformity | | | | | | | | |

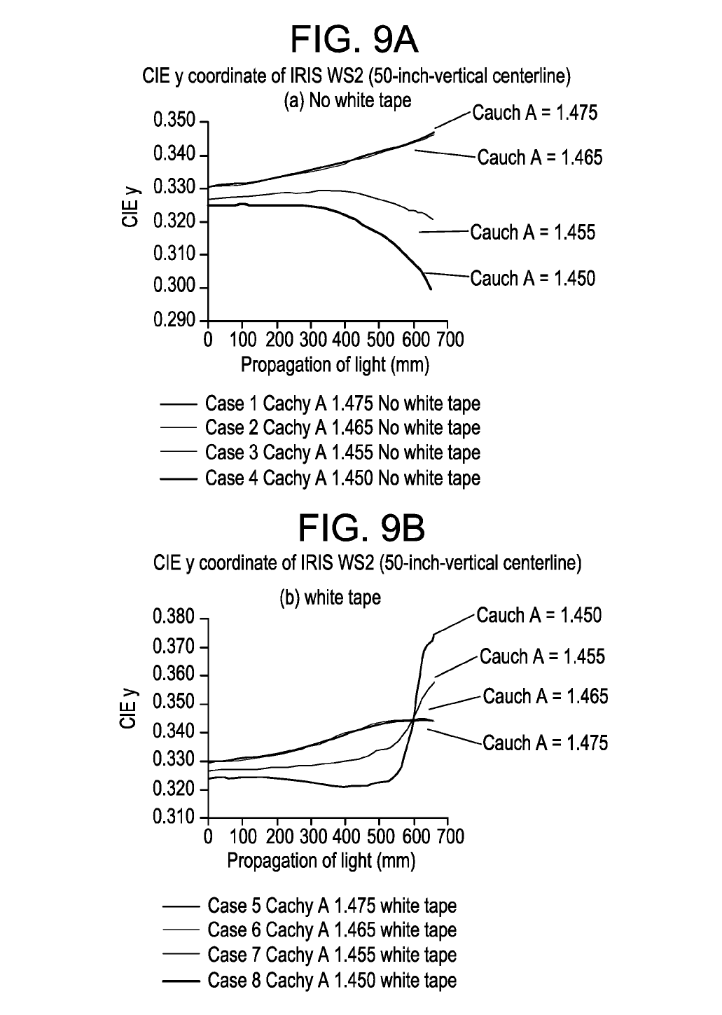

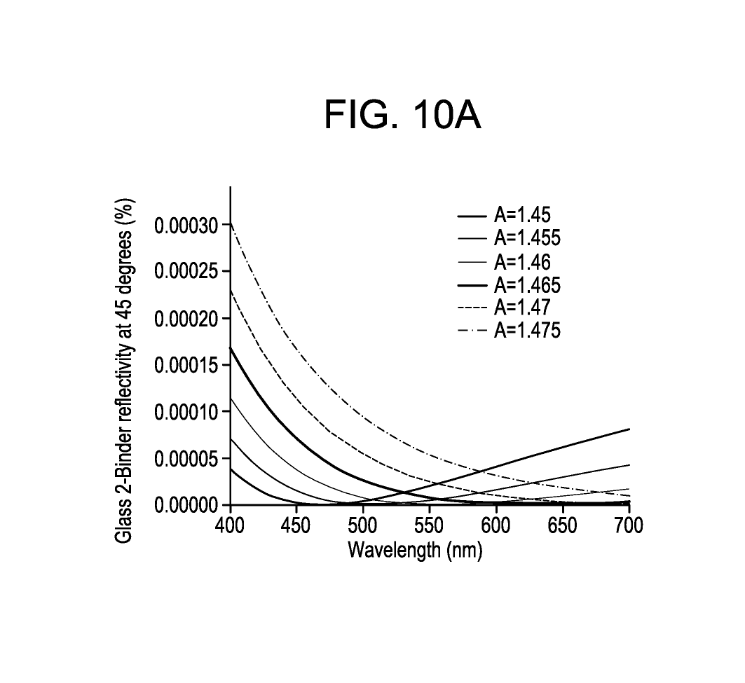

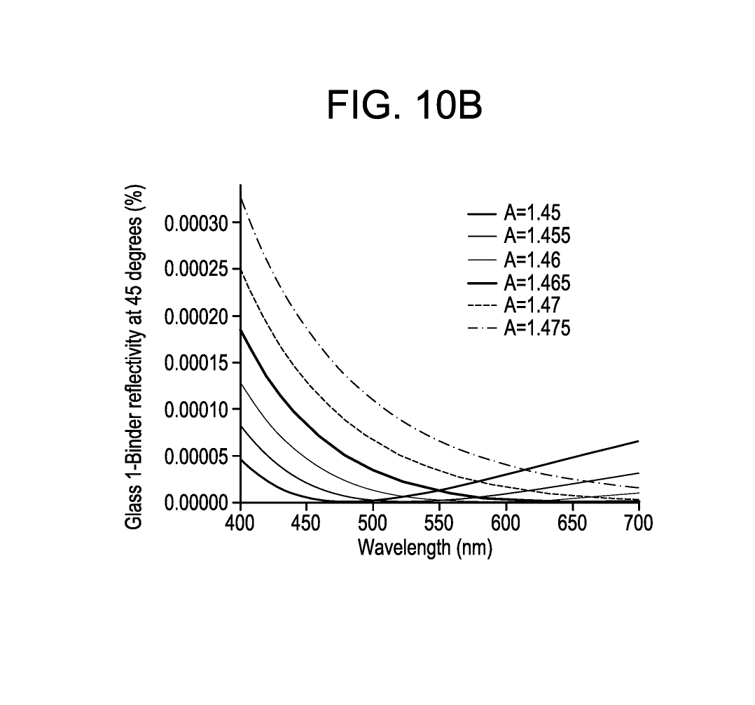

FIG. 9 is a series of plots of CIE y color coordinate as a function of distance for the light guide plates modeled in Table 1 above. With reference to FIG. 9, these plots demonstrate that, especially in the case of light guide plates without reflective tape on the far side (e.g., the edge opposite a light source), color uniformity across an exemplary light guide plate can be strongly influenced by the refractive index of the ink binder. FIGS. 10A and 10B are plots of Fresnel reflectivity of binders with the functional form of FIG. 8. With reference to FIGS. 10A and 10B, it can be observed that balancing the reflectivity across the wavelength range of interest can minimize overall color shift in an exemplary light guide plate.

Accordingly, light extraction features 220 contained in a glass article can have any suitable diameter d. In some embodiments, light extraction features can have a diameter d ranging from about 5 microns to about 1 mm, such as from about 5 microns to about 500 microns, from about 10 microns to about 400 microns, from about 20 microns to about 300 microns, from about 30 microns to about 250 microns, from about 40 microns to about 200 microns, from about 50 microns to about 150 microns, from about 60 microns to about 120 microns, from about 70 microns to about 100 microns, or from about 80 microns to about 90 microns, including all ranges and subranges therebetween. According to various embodiments, the diameter d of each light extraction feature can be identical to or different from the diameter d of other light extraction features in the plurality on or in a glass article.

Further, exemplary adjacent light extraction features 220 can have a distance x between them that is defined as the distance between the apexes of two adjacent light extraction features. According to various embodiments, the distance x can range from about 5 microns to about 2 mm, such as from about 10 microns to about 1.5 mm, from about 20 microns to about 1 mm, from about 30 microns to about 0.5 mm, or from about 50 microns to about 0.1 mm, including all ranges and subranges therebetween. It is to be understood that the distance x between pairs of adjacent light extraction features can vary in the plurality of light extraction features 220, with different pairs of adjacent extraction features spaced apart from one another at varying distances x.

In some embodiments, the distance x between adjacent light extraction features can be modified while maintaining the shape and size of the features themselves. For example, two non-limiting approaches can be used to vary the density of the features in the Z direction. According to a first approach, the density of features can be varied by changing the distance between neighboring features in both the X and Z directions (see FIG. 3). According to a second approach, the density of features can be varied by changing the distance between neighboring features in only one direction, for example only in the Z direction, or only in the X direction (see FIG. 4). In each of these approaches, one can assume that the features are arranged in regular rows in which each feature in a row has the same Z position.

According to the first approach, if the features are changed in both X and Z (as shown in FIG. 3), the rate of change of the pitch in the Z direction is constant and is given by the relationship below:

$$ΔΛ = ( {Λ}_{i} - {Λ}_{i - 1} ) = - \frac{{Λ}_{1}^{2} ( 1 - {η}_{LG} )}{2 {L}_{LG}} \qquad ( 3 )$$

With reference to equation (3) and FIG. 3, Λ₁ represents the pitch near the light source at Z=0, η_{LG} represents the efficiency of the light guide or glass article, and L_{LG} represents the length of the glass article in the Z direction. The total number of rows N between Z=0 and L can be represented by:

$$N = \frac{2 {L}_{LG}}{{Λ}_{1} ( 1 + \sqrt{{η}_{LG}} )} \qquad ( 4 )$$

An exemplary pattern 210b produced by this recipe is shown in FIG. 3.

According to this approach, if the spacing is changed in only the Z direction, the pitch along the rows will be a constant Λ₀, while pitch in Z will change by a ratio represented below:

$$r = \frac{{Λ}_{i}}{{Λ}_{i - 1}} = \frac{2 {L}_{LG} - {Λ}_{1} ( 1 - {η}_{LG} )}{2 {L}_{LG} + {Λ}_{1} ( 1 - {η}_{LG} )} \qquad ( 5 )$$

For this scenario, the number of rows is given by:

$$N = \frac{log ( 1 - \frac{{L}_{LG} ( 1 - r )}{{Λ}_{1}} )}{log ( r )} \qquad ( 6 )$$

A variant on the second approach is to keep the spacing between rows constant at Λ₀, but change the pitch along the row in the X direction by the values given by equation (5), and again the number of rows would be given by equation (6). Alternatively, a more complex or even randomized pattern may be chosen in which the simple design rules given by equations (3)-(6) are not used. In such an embodiment, a computer model can be used to choose the placement of individual light extraction features, or an iterative experimental process can be used. Even in the case of the designs given above and described herein, the values of Λ₀ and Λ₁ may be determined experimentally to obtain the desired uniformity and efficiency.

Color shift as described herein can be characterized by measuring the variation in y chromaticity coordinate along the length L using the CIE 1931 standard for color measurements. For glass light-guide plates the value of color shift can be reported as Δy=y(L₂)−y(L₁) where L₂ and L₁ are Z positions along the panel or substrate direction away from the source launch and where L₂−L₁=0.5 meters. Exemplary light-guide plates have Δy<0.01, Δy<0.005, Δy<0.003, or Δy<0.001.

Exemplary light guide plates can include a thickness between 0.2 mm and 4 mm, between 0.7 mm and 3 mm, and all subranges therebetween. Exemplary light extraction features can have a depth of between 1-200 microns, a minimum width at the glass surface of between 1 and 500 microns, a maximum width at the glass surface of between 1 and 500 microns, and/or aspect ratio (ratio of maximum to minimum width) at the glass surface of between 1 and 10.

Such embodiments can be used as a light guide in a backlight unit having one or more diffusing films, brightness enhancing films, and with an LED(s) coupling light into one or more sides of the light guide. In some embodiments, an exemplary pattern of light-extraction features can provide light extraction uniformity of greater than 80% across the light guide. In some embodiments, exemplary light guides can be used in a curved deployment with a radius of curvature between 2 and 6 meters.

The glass articles and light guide plates disclosed herein may be used in various display devices including, but not limited to LCDs or other displays used in the television, advertising, automotive, and other industries. Traditional backlight units used in LCDs can comprise various components. One or more light sources 120 may be used, for example light-emitting diodes (LEDs) or cold cathode fluorescent lamps (CCFLs). Conventional LCDs may employ LEDs or CCFLs packaged with color converting phosphors to produce white light. According to various aspects of the disclosure, display devices employing the disclosed glass articles may comprise at least one light source emitting blue light (UV light, approximately 100-400 nm), such as near-UV light (approximately 300-400 nm). The light guide plates and devices disclosed herein may also be used in any suitable lighting applications such as, but not limited to, luminaires or the like. In some embodiments, the glass articles can be used as a light guide in display devices, such as LCDs, in which a light source, e.g., LED, can be optically coupled to at least one edge of the light guide.

As used herein, the term “optically coupled” is intended to denote that a light source is positioned at an edge of the glass article so as to introduce light into the glass article. When light is injected into the glass article, e.g. glass light guide plate, according to certain embodiments, the light is trapped and bounces within the light guide due to TIR until it hits a light extraction feature on the first or second surface. As used herein, the term “light-emitting surface” is intended to denote a surface from which light is emitted from the light guide plate toward a viewer. For instance, the first or second surface can be a light-emitting surface. Similarly, the term “light-incident surface” is intended to denote a surface that is coupled to a light source, e.g., an LED, such that light enters the light guide. For example, the side edge of the light guide plate can be a light-incident surface.

The light extraction features can have an apex a (or highest point in the feature), and the distance x1 between light extraction features can be defined as the distance between the apexes of two adjacent light extraction features. According to various embodiments, the distance x1 can range from about 5 microns to about 2 mm, such as from about 10 microns to about 1.5 mm, from about 20 microns to about 1 mm, from about 30 microns to about 0.5 mm, or from about 50 microns to about 0.1 mm, including all ranges and subranges therebetween. It is to be understood that the distance x1 between each light extraction feature can vary in the plurality, with different extraction features spaced apart from one another at varying distances x1.

Ink jetting, screen printing, or other suitable deposition methods can be used to pattern the first and/or second surface of the glass article with a plurality of light extraction features. As used herein, the term “patterned” is intended to denote that the plurality of features are present on the surface of the glass article in any given pattern or design, which may, for example, be random or arranged, repetitive or non-repetitive, symmetrical or asymmetrical. According to various embodiments, the extraction features may be patterned in a suitable density so as to produce a substantially uniform illumination. For instance, the density of the light extraction features may vary along the length of the glass article (e.g., light guide plate), such as having a first density at a light-incident side of the article, with an increasing or decreasing density at various points along the length of the article.

In non-limiting embodiments, the glass article can be further processed before and/or after providing the features. For example, an exemplary glass substrate comprising a plurality of light extraction features can be subjected to a subsequent grinding, polishing, or etching steps to remove impurities on the surface thereof and/or to achieve a desired thickness or surface quality. Suitable etchants include hydrofluoric acid (HF) and/or hydrochloric acid (HCl) or any other suitable mineral or inorganic acid, e.g., nitric acid (HNO₃), sulfuric acid (HSO₄), and the like. The glass may also be optionally cleaned and/or the surface of the glass may be subjected to a process for removing contamination, such as exposing the surface to ozone or other cleaning agents.

Compositions

The glass article may also be chemically strengthened, e.g., by ion exchange. During the ion exchange process, ions within a glass article at or near the surface of the glass article may be exchanged for larger metal ions, for example, from a salt bath. The incorporation of the larger ions into the glass can strengthen the article by creating a compressive stress in a near surface region. A corresponding tensile stress can be induced within a central region of the glass article to balance the compressive stress.

Ion exchange may be carried out, for example, by immersing the glass in a molten salt bath for a predetermined period of time. Exemplary salt baths include, but are not limited to, KNO₃, LiNO₃, NaNO₃, RbNO₃, and combinations thereof. The temperature of the molten salt bath and treatment time period can vary. It is within the ability of one skilled in the art to determine the time and temperature according to the desired application. By way of a non-limiting example, the temperature of the molten salt bath may range from about 400° C. to about 800° C., such as from about 400° C. to about 500° C., and the predetermined time period may range from about 4 to about 24 hours, such as from about 4 hours to about 10 hours, although other temperature and time combinations are envisioned. By way of a non-limiting example, the glass can be submerged in a KNO₃ bath, for example, at about 450° C. for about 6 hours to obtain a K-enriched layer which imparts a surface compressive stress.

In various embodiments, the glass composition of the glass article may comprise between 60-80 mol % SiO₂, between 0-20 mol % Al₂O₃, and between 0-15 mol % B₂O₃, and less than 50 ppm iron (Fe) concentration. In some embodiments, there may be less than 25 ppm Fe, or in some embodiments the Fe concentration may be about 20 ppm or less. In various embodiments, the thermal conduction of the light guide plate 100 may be greater than 0.5 W/m/K. In additional embodiments, the glass article may be formed by a polished float glass, a fusion draw process, a slot draw process, a redraw process, or another suitable forming process.

According to one or more embodiments, the LGP can be made from a glass comprising colorless oxide components selected from the glass formers SiO₂, Al₂O₃, and B₂O₃. The exemplary glass may also include fluxes to obtain favorable melting and forming attributes. Such fluxes include alkali oxides (Li₂O, Na₂O, K₂O, Rb₂O and Cs₂O) and alkaline earth oxides (MgO, CaO, SrO, ZnO and BaO). In one embodiment, the glass contains constituents in the range of 60-80 mol % SiO₂, in the range of 0-20 mol % Al₂O₃, in the range of 0-15 mol % B₂O₃, and in the range of 5 and 20% alkali oxides, alkaline earth oxides, or combinations thereof.

In some glass compositions described herein, SiO₂ can serve as the basic glass former. In certain embodiments, the concentration of SiO₂ can be greater than 60 mole percent to provide the glass with a density and chemical durability suitable for a display glasses or light guide plate glasses, and a liquidus temperature (liquidus viscosity), which allows the glass to be formed by a downdraw process (e.g., a fusion process). In terms of an upper limit, in general, the SiO₂ concentration can be less than or equal to about 80 mole percent to allow batch materials to be melted using conventional, high volume, melting techniques, e.g., Joule melting in a refractory melter. As the concentration of SiO₂ increases, the 200 poise temperature (melting temperature) generally rises. In various applications, the SiO₂ concentration is adjusted so that the glass composition has a melting temperature less than or equal to 1,750° C. In various embodiments, the mol % of SiO₂ may be in the range of about 60% to about 80%, or alternatively in the range of about 66% to about 78%, or in the range of about 72% to about 80%, or in the range of about 65% to about 79%, and all subranges therebetween. In additional embodiments, the mol % of SiO₂ may be between about 70% to about 74%, or between about 74% to about 78%. In some embodiments, the mol % of SiO₂ may be about 72% to 73%. In other embodiments, the mol % of SiO₂ may be about 76% to 77%.

Al₂O₃ is another glass former used to make the glasses described herein. Higher mole percent Al₂O₃ can improve the glass's annealing point and modulus. In various embodiments, the mol % of Al₂O₃ may be in the range of about 0% to about 20%, or alternatively in the range of about 4% to about 11%, or in the range of about 6% to about 8%, or in the range of about 3% to about 7%, and all subranges therebetween. In additional embodiments, the mol % of Al₂O₃ may be between about 4% to about 10%, or between about 5% to about 8%. In some embodiments, the mol % of Al₂O₃ may be about 7% to 8%. In other embodiments, the mol % of Al₂O₃ may be about 5% to 6%.

B₂O₃ is both a glass former and a flux that aids melting and lowers the melting temperature. It has an impact on both liquidus temperature and viscosity. Increasing B₂O₃ can be used to increase the liquidus viscosity of a glass. To achieve these effects, the glass compositions of one or more embodiments may have B₂O₃ concentrations that are equal to or greater than 0.1 mole percent; however, some compositions may have a negligible amount of B₂O₃. As discussed above with regard to SiO₂, glass durability is very important for display applications. Durability can be controlled somewhat by elevated concentrations of alkaline earth oxides, and significantly reduced by elevated B₂O₃ content. Annealing point decreases as B₂O₃ increases, so it may be helpful to keep B₂O₃ content low. Thus, in various embodiments, the mol % of B₂O₃ may be in the range of about 0% to about 15%, or alternatively in the range of about 0% to about 12%, or in the range of about 0% to about 11%, in the range of about 3% to about 7%, or in the range of about 0% to about 2%, and all subranges therebetween. In some embodiments, the mol % of B₂O₃ may be about 7% to 8%. In other embodiments, the mol % of B₂O₃ may be about 0% to 1%.

In addition to the glass formers (SiO₂, Al₂O₃, and B₂O₃), the glasses described herein also include alkaline earth oxides. In one embodiment, at least three alkaline earth oxides are part of the glass composition, e.g., MgO, CaO, and BaO, and, optionally, SrO. The alkaline earth oxides provide the glass with various properties important to melting, fining, forming, and ultimate use. Accordingly, to improve glass performance in these regards, in one embodiment, the (MgO+CaO+SrO+BaO)/Al₂O₃ ratio is between 0 and 2.0. As this ratio increases, viscosity tends to increase more strongly than liquidus temperature, and thus it is increasingly difficult to obtain suitably high values for T₃₅ₖ−T_{liq}. Thus in another embodiment, ratio (MgO+CaO+SrO+BaO)/Al₂O₃ is less than or equal to about 2. In some embodiments, the (MgO+CaO+SrO+BaO)/Al₂O₃ ratio is in the range of about 0 to about 1.0, or in the range of about 0.2 to about 0.6, or in the range of about 0.4 to about 0.6. In some embodiments, the (MgO+CaO+SrO+BaO)/Al₂O₃ ratio is less than about 0.55 or less than about 0.4.

For certain embodiments of this disclosure, the alkaline earth oxides may be treated as what is in effect a single compositional component. This is because their impact upon viscoelastic properties, liquidus temperatures and liquidus phase relationships are qualitatively more similar to one another than they are to the glass forming oxides SiO₂, Al₂O₃ and B₂O₃. However, the alkaline earth oxides CaO, SrO and BaO can form feldspar minerals, notably anorthite (CaAl₂Si₂O₈) and celsian (BaAl₂Si₂O₈) and strontium-bearing solid solutions of same, but MgO does not participate in these crystals to a significant degree. Therefore, when a feldspar crystal is already the liquidus phase, a superaddition of MgO may serves to stabilize the liquid relative to the crystal and thus lower the liquidus temperature. At the same time, the viscosity curve typically becomes steeper, reducing melting temperatures while having little or no impact on low-temperature viscosities.

The addition of small amounts of MgO may benefit melting by reducing melting temperatures, forming by reducing liquidus temperatures and increasing liquidus viscosity, while preserving high annealing points. In various embodiments, the glass composition comprises MgO in an amount in the range of about 0 mol % to about 10 mol %, or in the range of about 1.0 mol % to about 8.0 mol %, or in the range of about 0 mol % to about 8.72 mol %, or in the range of about 1.0 mol % to about 7.0 mol %, or in the range of about 0 mol % to about 5 mol %, or in the range of about 1 mol % to about 3 mol %, or in the range of about 2 mol % to about 10 mol %, or in the range of about 4 mol % to about 8 mol %, and all subranges therebetween.

Without being bound by any particular theory of operation, it is believed that calcium oxide present in the glass composition can produce low liquidus temperatures (high liquidus viscosities), high annealing points and moduli, and coefficients of thermal expansion (CTEs, over the temperature range of 30 to 300° C.) in the most desired ranges for display and light guide plate applications. It also contributes favorably to chemical durability, and compared to other alkaline earth oxides, it is relatively inexpensive as a batch material. However, at high concentrations, CaO increases the density and CTE. Furthermore, at sufficiently low SiO₂ concentrations, CaO may stabilize anorthite, thus decreasing liquidus viscosity. Accordingly, in one or more embodiment, the CaO concentration can be between 0 and 6 mol %. In various embodiments, the CaO concentration of the glass composition is in the range of about 0 mol % to about 4.24 mol %, or in the range of about 0 mol % to about 2 mol %, or in the range of about 0 mol % to about 1 mol %, or in the range of about 0 mol % to about 0.5 mol %, or in the range of about 0 mol % to about 0.1 mol %, and all subranges therebetween.

SrO and BaO can both contribute to low liquidus temperatures (high liquidus viscosities). The selection and concentration of these oxides can be selected to avoid an increase in CTE and density and a decrease in modulus and annealing point. The relative proportions of SrO and BaO can be balanced so as to obtain a suitable combination of physical properties and liquidus viscosity such that the glass can be formed by a downdraw process. In various embodiments, the glass comprises SrO in the range of about 0 to about 8.0 mol %, or between about 0 mol % to about 4.3 mol %, or about 0 to about 5 mol %, about 1 mol % to about 3 mol %, or about less than about 2.5 mol %, and all subranges therebetween. In one or more embodiments, the glass comprises BaO in the range of about 0 to about 5 mol %, or between 0 to about 4.3 mol %, or between 0 to about 2.0 mol %, or between 0 to about 1.0 mol %, or between 0 to about 0.5 mol %, and all subranges therebetween.

In addition to the above components, the glass compositions described herein can include various other oxides to adjust various physical, melting, fining, and forming attributes of the glasses. Examples of such other oxides include, but are not limited to, TiO₂, MnO, Fe₂O₃, ZnO, Nb₂O₅, MoO₃, Ta₂O₅, WO₃, Y₂O₃, La₂O₃ and CeO₂ as well as other rare earth oxides and phosphates. In one embodiment, the amount of each of these oxides can be less than or equal to 2.0 mole percent, and their total combined concentration can be less than or equal to 5.0 mole percent. In some embodiments, the glass composition comprises ZnO in an amount in the range of about 0 to about 3.5 mol %, or about 0 to about 3.01 mol %, or about 0 to about 2.0 mol %, and all subranges therebetween. The glass compositions described herein can also include various contaminants associated with batch materials and/or introduced into the glass by the melting, fining, and/or forming equipment used to produce the glass. The glasses can also contain SnO₂ either as a result of Joule melting using tin-oxide electrodes and/or through the batching of tin containing materials, e.g., SnO₂, SnO, SnCO₃, SnC₂O₂, etc.

The glass compositions described herein can contain some alkali constituents, e.g., these glasses are not alkali-free glasses. As used herein, an “alkali-free glass” is a glass having a total alkali concentration which is less than or equal to 0.1 mole percent, where the total alkali concentration is the sum of the Na₂O, K₂O, and Li₂O concentrations. In some embodiments, the glass comprises Li₂O in the range of about 0 to about 3.0 mol %, in the range of about 0 to about 3.01 mol %, in the range of about 0 to about 2.0 mol %, in the range of about 0 to about 1.0 mol %, less than about 3.01 mol %, or less than about 2.0 mol %, and all subranges therebetween. In other embodiments, the glass comprises Na₂O in the range of about 3.5 mol % to about 13.5 mol %, in the range of about 3.52 mol % to about 13.25 mol %, in the range of about 4 to about 12 mol %, in the range of about 6 to about 15 mol %, or in the range of about 6 to about 12 mol %, and all subranges therebetween. In some embodiments, the glass comprises K₂O in the range of about 0 to about 5.0 mol %, in the range of about 0 to about 4.83 mol %, in the range of about 0 to about 2.0 mol %, in the range of about 0 to about 1.0 mol %, or less than about 4.83 mol %, and all subranges therebetween.

In some embodiments, the glass compositions described herein can have one or more or all of the following compositional characteristics: (i) an As₂O₃ concentration of at most 0.05 mole percent; (ii) an Sb₂O₃ concentration of at most 0.05 mole percent; (iii) a SnO₂ concentration of at most 0.25 mole percent.

As₂O₃ is an effective high temperature fining agent for display glasses, and in some embodiments described herein, As₂O₃ is used for fining because of its superior fining properties. However, As₂O₃ is poisonous and requires special handling during the glass manufacturing process. Accordingly, in certain embodiments, fining is performed without the use of substantial amounts of As₂O₃, i.e., the finished glass has at most 0.05 mole percent As₂O₃. In one embodiment, no As₂O₃ is purposely used in the fining of the glass. In such cases, the finished glass will typically have at most 0.005 mole percent As₂O₃ as a result of contaminants present in the batch materials and/or the equipment used to melt the batch materials.

Although not as toxic as As₂O₃, Sb₂O₃ is also poisonous and requires special handling. In addition, Sb₂O₃ raises the density, raises the CTE, and lowers the annealing point in comparison to glasses that use As₂O₃ or SnO₂ as a fining agent. Accordingly, in certain embodiments, fining is performed without the use of substantial amounts of Sb₂O₃, i.e., the finished glass has at most 0.05 mole percent Sb₂O₃. In another embodiment, no Sb₂O₃ is purposely used in the fining of the glass. In such cases, the finished glass will typically have at most 0.005 mole percent Sb₂O₃ as a result of contaminants present in the batch materials and/or the equipment used to melt the batch materials.

Compared to As₂O₃ and Sb₂O₃ fining, tin fining (i.e., SnO₂ fining) is less effective, but SnO₂ is a ubiquitous material that has no known hazardous properties. Also, for many years, SnO₂ has been a component of display glasses through the use of tin oxide electrodes in the Joule melting of the batch materials for such glasses. The presence of SnO₂ in display glasses has not resulted in any known adverse effects in the use of these glasses in the manufacture of liquid crystal displays. However, high concentrations of SnO₂ are not preferred as this can result in the formation of crystalline defects in display glasses. In one embodiment, the concentration of SnO₂ in the finished glass is less than or equal to 0.25 mole percent, in the range of about 0.07 to about 0.11 mol %, in the range of about 0 to about 2 mol %, and all subranges therebetween.

Tin fining can be used alone or in combination with other fining techniques if desired. For example, tin fining can be combined with halide fining, e.g., bromine fining. Other possible combinations include, but are not limited to, tin fining plus sulfate, sulfide, cerium oxide, mechanical bubbling, and/or vacuum fining. It is contemplated that these other fining techniques can be used alone. In certain embodiments, maintaining the (MgO+CaO+SrO+BaO)/Al₂O₃ ratio and individual alkaline earth concentrations within the ranges discussed above makes the fining process easier to perform and more effective.

In various embodiments, the glass may comprise RₓO where R is Li, Na, K, Rb, Cs, and x is 2, or R is Zn, Mg, Ca, Sr or Ba, and x is 1. In some embodiments, RₓO—Al₂O₃>0. In other embodiments, 0<RₓO—Al₂O₃<15. In some embodiments, RₓO/Al₂O₃ is between 0 and 10, between 0 and 5, greater than 1, or between 1.5 and 3.75, or between 1 and 6, or between 1.1 and 5.7, and all subranges therebetween. In other embodiments, 0<RₓO—Al₂O₃<15. In further embodiments, x=2 and R₂O—Al₂O₃<15, <5, <0, between −8 and 0, or between −8 and −1, and all subranges therebetween. In additional embodiments, R₂O—Al₂O₃<0. In yet additional embodiments, x=2 and R₂O—Al₂O₃—MgO>−10, >−5, between 0 and −5, between 0 and −2, >−2, between −5 and 5, between −4.5 and 4, and all subranges therebetween. In further embodiments, x=2 and RₓO/Al₂O₃ is between 0 and 4, between 0 and 3.25, between 0.5 and 3.25, between 0.95 and 3.25, and all subranges therebetween. These ratios play significant roles in establishing the manufacturability of the glass article as well as determining its transmission performance. For example, glasses having RₓO—Al₂O₃ approximately equal to or larger than zero will tend to have better melting quality but if RₓO—Al₂O₃ becomes too large of a value, then the transmission curve will be adversely affected. Similarly, if RₓO—Al₂O₃ (e.g., R₂O—Al₂O₃) is within a given range as described above then the glass will likely have high transmission in the visible spectrum while maintaining meltability and suppressing the liquidus temperature of a glass. Similarly, the R₂O—Al₂O₃—MgO values described above may also help suppress the liquidus temperature of the glass.

In one or more embodiments and as noted above, exemplary glasses can have low concentrations of elements that produce visible absorption when in a glass matrix. Such absorbers include transition elements such as Ti, V, Cr, Mn, Fe, Co, Ni and Cu, and rare earth elements with partially-filled f-orbitals, including Ce, Pr, Nd, Sm, Eu, Tb, Dy, Ho, Er and Tm. Of these, the most abundant in conventional raw materials used for glass melting are Fe, Cr and Ni. Iron is a common contaminant in sand, the source of SiO₂, and is a typical contaminant as well in raw material sources for aluminum, magnesium and calcium. Chromium and nickel are typically present at low concentration in normal glass raw materials, but can be present in various ores of sand and must be controlled at a low concentration. Additionally, chromium and nickel can be introduced via contact with stainless steel, e.g., when raw material or cullet is jaw-crushed, through erosion of steel-lined mixers or screw feeders, or unintended contact with structural steel in the melting unit itself. The concentration of iron in some embodiments can be specifically less than 50 ppm, more specifically less than 40 ppm, or less than 25 ppm, and the concentration of Ni and Cr can be specifically less than 5 ppm, and more specifically less than 2 ppm. In further embodiments, the concentration of all other absorbers listed above may be less than 1 ppm for each. In various embodiments the glass comprises 1 ppm or less of Co, Ni, and Cr, or alternatively less than 1 ppm of Co, Ni, and Cr. In various embodiments, the transition elements (V, Cr, Mn, Fe, Co, Ni and Cu) may be present in the glass at 0.1 wt % or less. In some embodiments, the concentration of Fe can be <about 50 ppm, <about 40 ppm, <about 30 ppm, <about 20 ppm, or <about 10 ppm. In other embodiments, Fe+30Cr+35Ni<about 60 ppm, <about 50 ppm, <about 40 ppm, <about 30 ppm, <about 20 ppm, or <about 10 ppm.

Even in the case that the concentrations of transition metals are within the above described ranges, there can be matrix and redox effects that result in undesired absorption. As an example, it is well-known to those skilled in the art that iron occurs in two valences in glass, the +3 or ferric state, and the +2 or ferrous state. In glass, Fe³⁺ produces absorptions at approximately 380, 420 and 435 nm, whereas Fe²⁺ absorbs mostly at IR wavelengths. Therefore, according to one or more embodiments, it may be desirable to force as much iron as possible into the ferrous state to achieve high transmission at visible wavelengths. One non-limiting method to accomplish this is to add components to the glass batch that are reducing in nature. Such components could include carbon, hydrocarbons, or reduced forms of certain metalloids, e.g., silicon, boron or aluminum. However it is achieved, if iron levels were within the described range, according to one or more embodiments, at least 10% of the iron in the ferrous state and more specifically greater than 20% of the iron in the ferrous state, improved transmissions can be produced at short wavelengths. Thus, in various embodiments, the concentration of iron in the glass produces less than 1.1 dB/500 mm of attenuation in the glass article. Further, in various embodiments, the concentration of V+Cr+Mn+Fe+Co+Ni+Cu produces 2 dB/500 mm or less of light attenuation in the glass article when the ratio (Li₂O+Na₂O+K₂O+Rb₂O+Cs₂O+MgO+ZnO+CaO+SrO+BaO)/Al₂O₃ for borosilicate glass is between 0 and 4.

The valence and coordination state of iron in a glass matrix can also be affected by the bulk composition of the glass. For example, iron redox ratio has been examined in molten glasses in the system SiO₂—K₂O—Al₂O₃ equilibrated in air at high temperature. It was found that the fraction of iron as Fe³⁺ increases with the ratio K₂O/(K₂O+Al₂O₃), which in practical terms will translate to greater absorption at short wavelengths. In exploring this matrix effect, it was discovered that the ratios (Li₂O+Na₂O+K₂O+Rb₂O+Cs₂O)/Al₂O₃ and (MgO+CaO+ZnO+SrO+BaO)/Al₂O₃ can also be important for maximizing transmission in borosilicate glasses. Thus, for the RₓO ranges described above, transmission at exemplary wavelengths can be maximized for a given iron content. This is due in part to the higher proportion of Fe²⁺, and partially to matrix effects associated with the coordination environment of iron.

It will be appreciated that the various disclosed embodiments may involve particular features, elements or steps that are described in connection with that particular embodiment. It will also be appreciated that a particular feature, element or step, although described in relation to one particular embodiment, may be interchanged or combined with other features or alternate embodiments in various non-illustrated combinations or permutations.

It is also to be understood that, as used herein the terms “the,” “a,” or “an,” mean “at least one,” and should not be limited to “only one” unless explicitly indicated to the contrary. Thus, for example, reference to “a light source” includes examples having two or more such light sources unless the context clearly indicates otherwise. Likewise, a “plurality” is intended to denote “more than one.” As such, a “plurality of light extraction features” includes two or more such features, such as three or more such features, etc.

Ranges can be expressed herein as from “about” one particular value, and/or to “about” another particular value. When such a range is expressed, examples include from the one particular value and/or to the other particular value. Similarly, when values are expressed as approximations, by use of the antecedent “about,” it will be understood that the particular value forms another aspect. It will be further understood that the endpoints of each of the ranges are significant both in relation to the other endpoint, and independently of the other endpoint.

The terms “substantial,” “substantially,” and variations thereof as used herein are intended to note that a described feature is equal or approximately equal to a value or description. For example, a “substantially planar” surface is intended to denote a surface that is planar or approximately planar.

Unless otherwise expressly stated, it is in no way intended that any method set forth herein be construed as requiring that its steps be performed in a specific order. Accordingly, where a method claim does not actually recite an order to be followed by its steps or it is not otherwise specifically stated in the claims or descriptions that the steps are to be limited to a specific order, it is no way intended that any particular order be inferred.

While various features, elements or steps of particular embodiments may be disclosed using the transitional phrase “comprising,” it is to be understood that alternative embodiments, including those that may be described using the transitional phrases “consisting” or “consisting essentially of,” are implied. Thus, for example, implied alternative embodiments to a method that comprises A+B+C include embodiments where a method consists of A+B+C and embodiments where a method consists essentially of A+B+C.

It will be apparent to those skilled in the art that various modifications and variations can be made to the present disclosure without departing from the spirit and scope of the disclosure. Since modifications combinations, sub-combinations and variations of the disclosed embodiments incorporating the spirit and substance of the disclosure may occur to persons skilled in the art, the disclosure should be construed to include everything within the scope of the appended claims and their equivalents.

1. A glass article comprising:
a first surface and an opposing second surface,
wherein the first surface comprises a plurality of light extraction features, ones of the plurality of light extraction features having scattering particles and binder material,
wherein the plurality of light extraction features produces a color shift Δy<0.01 per 500 mm of length, and
wherein a difference in Fresnel reflections at an interface of the first surface and the respective extraction feature at 45 degrees measured within the glass article at 450 nm and 630 nm is less than 0.015%.

2. The glass article of claim 1, wherein the difference is less than 0.005%.

3. The glass article of claim 1, wherein the difference is less than 0.001%

4. The glass article of claim 1, wherein ones of the plurality of light extraction features have a minimum width at the first surface of between 1 micron and 500 microns, a maximum width at the first surface of between 1 micron and 500 microns, an aspect ratio at the first surface of between 1 and 10, or combinations thereof.

5. The glass of claim 1, wherein the glass article has a thickness of between 0.2 mm and 4 mm.

6. The glass article of claim 5, wherein the glass article has a thickness of 0.7 mm, 1.1 mm or 2 mm.

7. The glass article of claim 1, wherein the glass article further comprises a diffusing film, a brightness enhancing film, or both.

8. The glass article of claim 1, wherein the glass article further comprises one or more light sources coupling light into one or more sides of the glass article.

9. The glass article of claim 1, wherein the plurality of light extraction features provide a light extraction uniformity of >80% across the glass article.

10. The glass article of claim 1, wherein the glass article is curved with a radius of curvature between 2 m and 6 m.

11. The glass article of claim 1, wherein the plurality of light extraction features is present on the first surface in a pattern selected from the group consisting of random, arranged, repetitive, non-repetitive, symmetrical, and asymmetrical.

12. The glass article of claim 1, wherein any one or combination of the diameters and geometries of the light extraction features vary as a function of position on the first surface.

13. The glass article of claim 1, wherein the opposing second surface comprises a second plurality of light extraction features.

14. A display device or luminaire comprising the glass article of claim 1.

15. A light extracting ink comprising scattering particles and a binder material, wherein Fresnel reflections between the binder material and an adjacent substrate are substantially invariant with respect to wavelength.

16. A light extracting ink comprising scattering particles and a binder material, wherein the binder material has an index of refraction equal to that of an adjacent substrate at a single wavelength.

17. A light guide plate having light extraction features containing the light extracting ink of claim 15 or claim 16.

18. The light guide plate of claim 17, wherein the plurality of light extraction features produces a color shift Δy<0.01 per 500 mm of length.

19. The light guide plate of claim 15 or 16, wherein the light guide plate comprises glass.
